(19) United States
(12) Patent Application Publication
(10) Pub. No.: US 2009/0242572 A1
(43) Pub. Date: Oct. 1, 2009

(54) Teapot

(75) Inventor: Masakazu Fujii, Rancho Palos Verdes, CA (US)

Correspondence Address: WPAT, PC, 7225 BEVERLY ST., ANNANDALE, VA, 22003, US

(73) Assignee: Masakazu Fujii, Rancho Palos Verdes, CA (US)

(21) Appl. No.: 12/056,545

(22) Filed: Mar. 27, 2008

(51) Int. Cl. A47J 31/00; B65D 25/40

(52) U.S. Cl. 220/573.1; 222/566

(57) ABSTRACT

The present invention discloses a teapot. The teapot comprises a teapot body, a loading plate, a handle, and an upper top. The teapot body has an open part and a chink, wherein the open part dents inward for composing an inner space in the teapot body. Besides, the chink sweeps downward from the edge of the open part. The loading plate crossly is sited under the open part. The handle is sited on the outside of the teapot body and the handle has a salient part and a sweep part. The salient part is protrusive from the edge of the open part to the inner of the open part, and the sweep part stretches from the top of the salient part to the inner of the open part. The upper top comprises a guarding skirt, and the guarding skirt fits with the open part. The guarding skirt comprises a gap corresponding to the chink, wherein the upper top forms an external edge around the guarding skirt. The external edge comprises a buckle space and the site of the buckle space is corresponding to the salient part, even the buckle space can contain the salient part.

### BACKGROUND OF THE INVENTION

1. Field of the Invention

The present invention is generally related to a teapot, and more particularly to the teapot enabling a tea bag to be placed outside water.

2. Description of the Prior Art

Traditionally, the tea bag needs to soak in the water all the while to make tea. When use a small teapot to make tea, in order to avoid the overly steep, the tea bag must be thrown away after slightly using. That is a squander. In this circumstance, the tea bag could be reused. Limiting to the teapot design of the prior art, it is inconvenient to place the tea bag and the water individually. For above-mentioned reasons, the more prefect design is needed.

### SUMMARY OF THE INVENTION

In view of the above background and in order to fulfill the requirements of industry, a new teapot is provided in the present invention.

One subject of the present invention is to provide a teapot. The teapot comprises a teapot body, a loading plate, a handle and an upper top. The teapot body has an open part and a chink, the open part dents inward for composing an inner space in the teapot body. Besides, the chink sweeps downward from the edge of the open part. The loading plate crossly sites under the open part. The handle sites on the outside of the teapot body and moreover have a salient part and a sweep part. Besides, the salient part is protrusive from the edge of the open part to the inner of the open part, and the sweep part stretches from the top of the salient part to the inner of the open part. The upper top has a guarding skirt, and the guarding skirt fits with the open part. The guarding skirt has a gap corresponding to the chink, wherein the upper top forms an external edge around the guarding skirt. The external edge comprises a buckle space and the site of the buckle space is corresponding to the salient part, even the buckle space can contain the salient part.

### BRIEF DESCRIPTION OF THE DRAWINGS

FIG. 1˜FIG. 2 shows the teapot diagram of the present invention;

FIG. 3 shows the cross-section diagram of the teapot in this present invention;

FIG. 4˜FIG. 6 shows the diagram of using with the tea bag; and

FIG. 7 shows the completely fabrication of the teapot.

### DETAILED DESCRIPTION OF THE PREFERRED EMBODIMENTS

What is probed into the invention is teapot. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

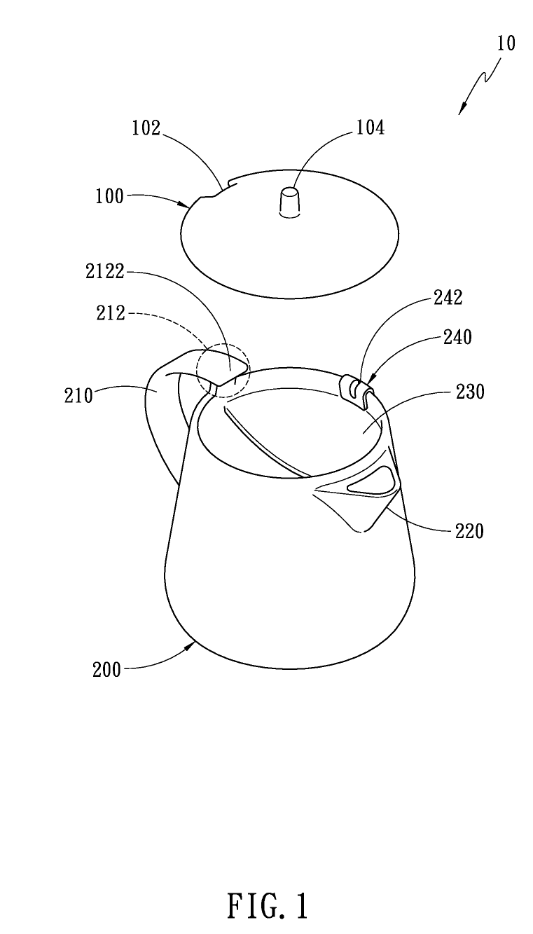

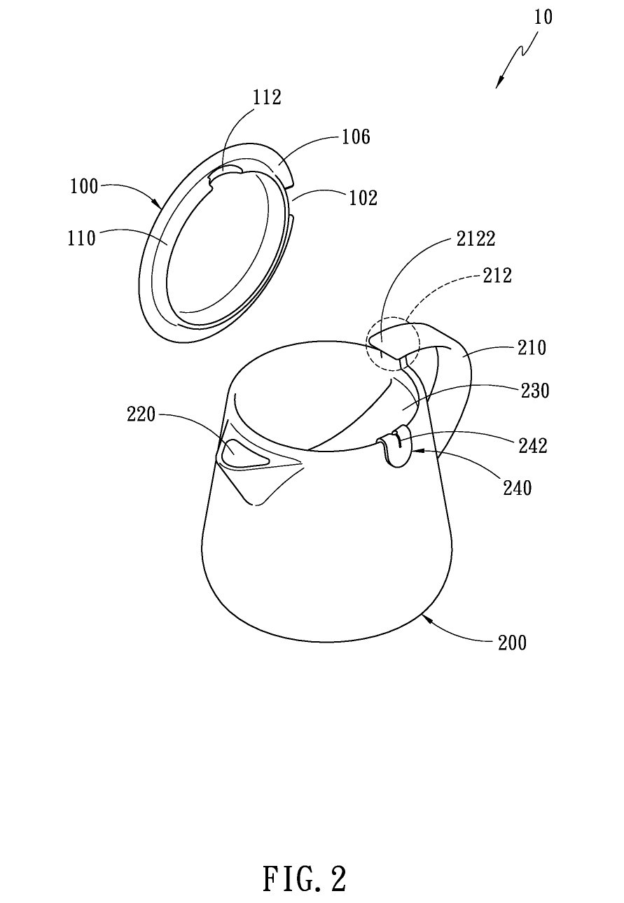

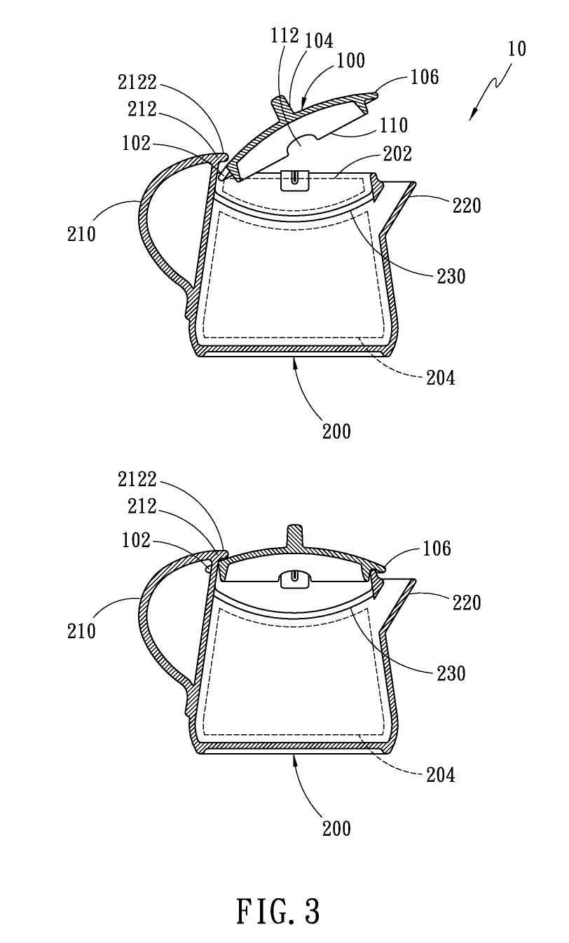

FIG. 1, FIG. 2, and FIG. 3 are diagrams of a teapot 10. The teapot 10 comprises a teapot body 200, a loading plate 230, a handle 210, a spout 220, and an upper top 100.

The teapot body 200 has an open part and a chink 242, the open part dents inward for composing an inner space 204 in the teapot body 200, besides, the chink 242 sweeps downward from the edge of the open part, and the loading plate 230 crossly sites under the open part.

Further, the handle 210 sites on the outside of the teapot body 200 and moreover have a salient part 212 and a sweep part 2122. Besides, the salient part 212 is protrusive from the edge of the open part to the inner of the open part, and the sweep part 2122 stretches from the top of the salient part 212 to the inner of the open part, wherein the buckle space 102 fits with the salient part 212.

Moreover, an upper top 100 has a guarding skirt 110, and the guarding skirt 110 fits with the open part. The guarding skirt 110 has a gap 112 corresponding to the chink 242, wherein the upper top 100 forms an external edge around the guarding skirt 110. The external edge has a buckle space 102 and the site of the buckle space 102 is corresponding to the salient part 212, even the buckle space 102 can contain the salient part 212. Additionally, the teapot according to this embodiment further comprises a stem 104 deposited above the upper top 100.

Furthermore, the spout 220 has an outlet, the outlet sites outside the teapot body 200.

In one preferred example according to this embodiment, as shown in FIG. 3, the sweep part 2122 keeps a first distance from the open part. The first distance is larger than the thickness of the external edge 106, so the external edge 106 of the upper top 100 can be placed under the sweep part 2122. The buckle space 102 of the upper top 100 oblique inserts in the salient part 212, and then fair places on the open part, and the upper top 100 is supported above the open part by the external edge 106. When pouring, the upper top 100 uses a part of the external edge or the guarding skirt 110 as a fulcrum. Furthermore, utilize the sweep part 2122 to lock the upper top 100. Keep the upper top 100 above the open part.

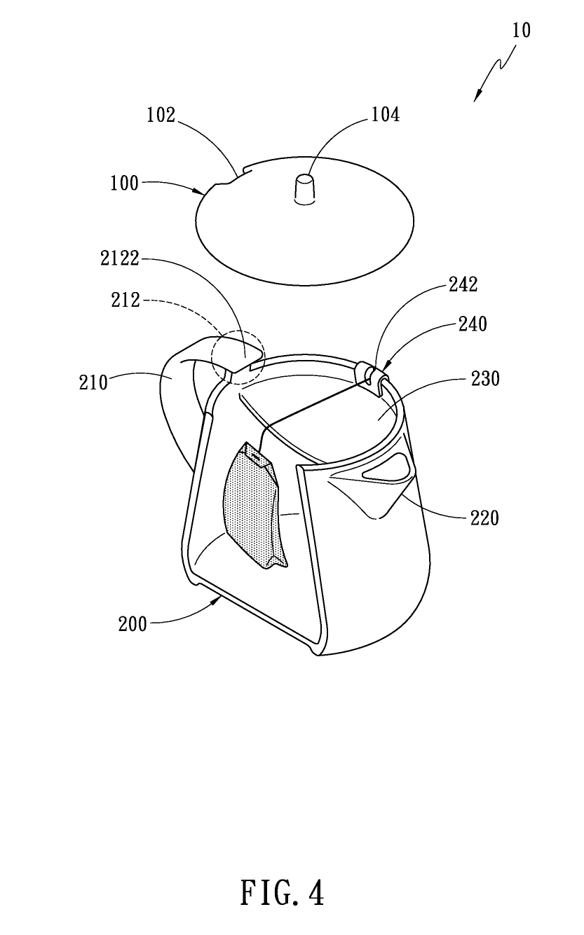

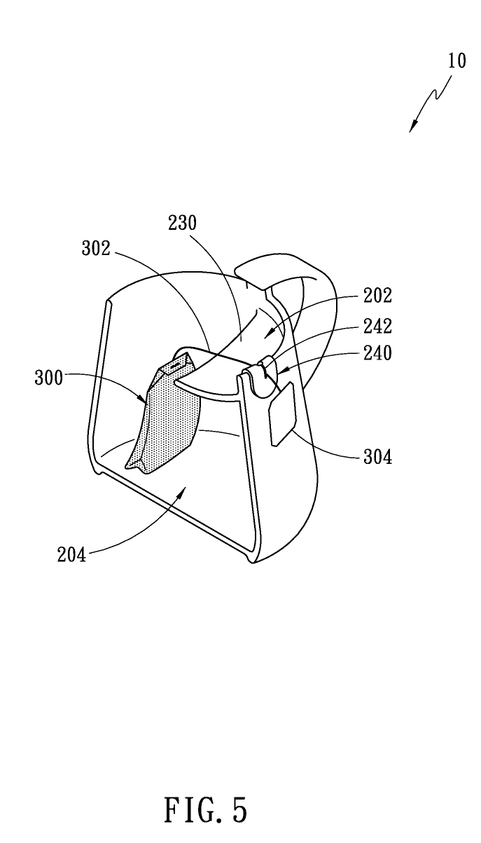

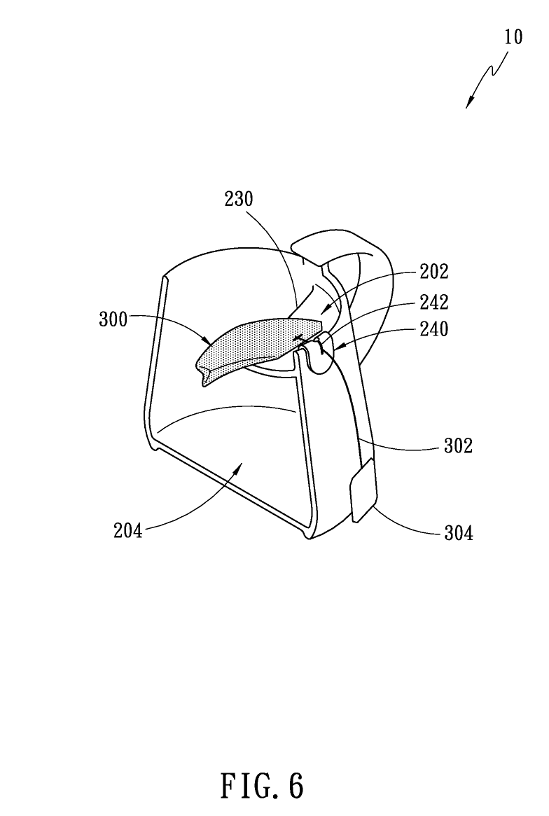

In another preferred example according to this embodiment, the teapot further comprises a chink pad 240 sited upper the chink 242. The chink pad 240 dents downward and the chink 242 is wrapped by the chink pad 240. The mentioned chink pad 240 is constructed of an elastic material. When a tea bag 300 is placed in the inner space 204, as shown in FIG. 4 and FIG. 5, a pull-line 302 of the tea bag 300 can be clipped by the chink pad 242. The tea bag 300 can be pulled up by the lint 304 of the pull-line 302.

In still another preferred example according to this embodiment, the teapot further comprises a loading plate 230. The loading plate 230 is sited under the chink 242. The loading plate 230 keeps a second distance from the open part, and the stretching height downward from the upper top 100 to the guarding skirt 110 is small than or equal to the second distance. A loading space 202 is formed by the loading plate 230 and the open part, and the loading space 202 can be used to place tea bags, as shown in FIG. 6. The loading plate 230 tilts from the teapot body 200 to the open part. Therefore, when placing a tea bag 300 on the loading plate 230, the ooze tea of the tea bag 300 can flow into the inner space 204.

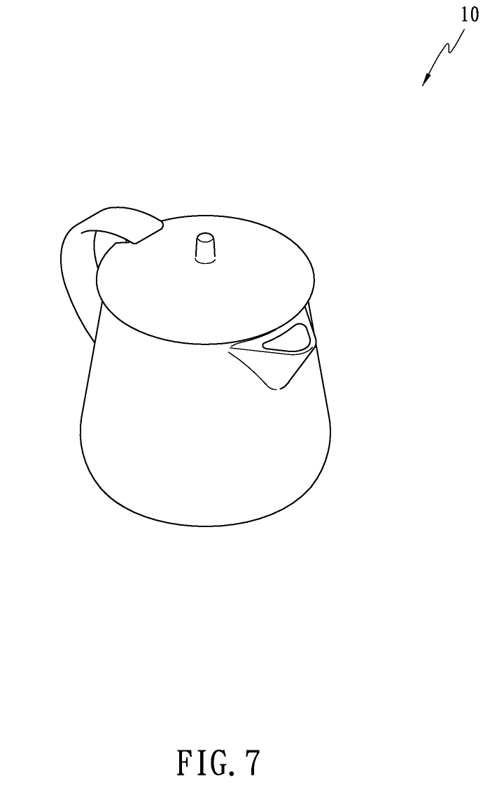

In view of the above, even covering the open part with the upper top 100, as shown in FIG. 7, the tea bag 300 can be completely placed on the loading plate 230. The tea bag 300 would not soak in the water all the while, so that the overly steep can be avoided.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A teapot comprising:
a teapot body having a open part and a chink, wherein the open part dents inward for composing an inner space in the teapot body, and the chink sweeps downward from the edge of the open part;
a loading plate crossly sited under the open part;
a handle sited on the outside of the teapot body, wherein the handle comprises a salient part and a sweep part, wherein the salient part is protrusive from the edge of the open part to the inner of the open part, and the sweep part stretches from the top of the salient part to the inner of the open part; and
an upper top having a guarding skirt, the guarding skirt fits with the open part, the guarding skirt have a gap corresponding to the chink, and the upper top further comprises an external edge around the guarding skirt, wherein the external edge comprises a buckle space and the site of the buckle space is corresponding to the salient part, the buckle space can contain the salient part.

2. The teapot according to claim 1 further comprising a spout, wherein the spout is linked with the inner space.

3. The teapot according to claim 2, wherein the spout comprises an outlet outside the teapot body.

4. The teapot according to claim 1, wherein the sweep part keeps a first distance from the open part, and the first distance is larger than the thickness of the external edge.

5. The teapot according to claim 1, wherein the buckle space fits with the salient part.

6. The teapot according to claim 1, wherein the loading plate is sited under the chink.

7. The teapot according to claim 1, wherein the loading plate keeps a second distance from the open part, the stretch height downward from the upper top to the guarding skirt is smaller than or equal to the second distance.

8. The teapot according to claim 1, wherein the loading plate tilts from the teapot body to the open part.

9. The teapot according to claim 1 further comprising a chink pad, wherein the chink pad is sited upper the chink, and the chink pad dents downward and wraps the chink.

10. The teapot according to claim 1, wherein the chink pad constructs of the elastic materials.
